(19) United States
(12) Patent Application Publication
(10) Pub. No.: US 2011/0226697 A1
(43) Pub. Date: Sep. 22, 2011

(54) Functional Nanofibers and Methods of Making and Using the Same

(75) Inventors: Joseph M. McLellan, Quincy, MA (US); Xinhua Li, Newton, MA (US); Graciela Beatriz Blanchet, Boston, MA (US); David Picard, Jamaica Plains, MA (US)

(73) Assignee: Nano Terra Inc., Cambridge, MA (US)

(21) Appl. No.: 12/886,105

(22) Filed: Sep. 20, 2010

Related U.S. Application Data
(60) Provisional application No. 61/243,917, filed on Sep. 18, 2009.
(60) Provisional application No. 61/294,411, filed on Jan. 12, 2010.

(51) Int. Cl. B01D 71/68; C01B 31/20; C08F 8/32; B01D 61/00; B01D 19/00; B01D 71/06; B01D 71/48; B01D 71/54; B82Y 99/00

(52) U.S. Cl. 210/651; 423/437.1; 525/381; 96/6; 95/46; 977/902; 977/700

(57) ABSTRACT

The present invention is directed to functional nanofibers, methods of making the functional nanofibers, and products such as filters and membranes comprising mats of the functional nanofibers.

### CROSS-REFERENCE TO RELATED APPLICATIONS

This application claims the benefit of the filing date of U.S. Provisional Appl. No. 61/243,917, filed Sep. 18, 2009, and U.S. Provisional Appl. No. 61/294,411, filed Jan. 12, 2010, both of which are incorporated herein by reference in the entirety.

### BACKGROUND OF THE INVENTION

1. Field of the Invention

The present invention is directed to functional nanofibers suitable for use as, for example, filters and membranes, methods for making the functional nanofibers, and products prepared using the functional nanofibers.

2. Background

Environmental control and remediation is a pressing concern for both industrialized and developing countries, and metals, oils, and greenhouse gases are of particular concern.

With respect to greenhouse gases, coal fired power plants are the single biggest source of CO₂ emissions in the United States, and coal accounts for 44% of U.S. energy. According to the most recent report from the U.S. Department of Energy (“the DOE”), coal-fired power plants were responsible for 1.9 billion metric tons or 32% of CO₂ emissions in 2008. Carbon Capture and Storage (“CCS”) has the potential to provide an effective and easily implemented system of emissions control. Unlike pre-combustion and oxy-fuel combustion systems, CCS systems do not require large amounts of energy in order to operate and do not require extensive retro-fitting of existing power plants.

According to the DOE, the current state-of-the-art CCS system is a monoethanolamine (“MEA”) scrubber. However, there are extensive upfront costs associated with installing an MEA system, and MEA is a corrosive chemical reagent. Furthermore, overheating and the presence of even trace amounts of SO₂ can degrade MEA. Aside from these reasons, MEA technology is not suited to widespread adoption because a large amount of additional energy is required to remove CO₂ from the MEA sorbent. Specifically, after the MEA sorbent becomes “CO₂-rich” it is piped to an area where it is reacted with steam to release the CO₂ into the steam, thereby regenerating the MEA sorbent. This steam then is condensed and reboiled, and pure CO₂ is separated from the water. Thus, significant energy is needed to regenerate the MEA and isolate the CO₂.

Membranes for CO₂ capture based on carbon nanotubes have been proposed. However, the membrane materials developed thus far do not exhibit a high degree of selectivity (e.g., CO₂:N₂ ratio) and are expensive to fabricate (a carbon nanotube concentration of 0.1% by weight in a filter material would raise the cost of the filter by USD 120 to 200 per kilogram).

In addition, waterproof breathable membranes are typically formed through the use of porogens.

### BRIEF SUMMARY OF THE INVENTION

What is needed is a cost-effective method for forming water-proof, breathable membranes without the use of porogens. What is also needed is a polymer composition that can be easily derivatized to create hydrophilic and/or hydrophobic areas, or a reactive surface.

Furthermore, a method is needed to sharply decrease emissions while having a minimal effect on the everyday lives of citizens. The functional nanofibers and methods disclosed herein provide a low-cost method to significantly reduce CO₂ emissions.

In some embodiments, the present invention is directed to a method for sequestering carbon dioxide. In some embodiments, a method comprises contacting a composition comprising carbon dioxide with functional nanofibers having an plurality of amine groups on a surface thereof. In some embodiments, the nanofibers have an average cross-sectional dimension of 50 nm to 100 μm. In some embodiments, the method comprises reacting at least a portion of the carbon dioxide with the amine groups to sequester at least a portion of the carbon dioxide.

In some embodiments, the method comprises releasing the sequestered carbon dioxide from the functional nanofibers.

In some embodiments, at least a portion of the amine groups are secondary amines. Thus, in some embodiments the reacting comprises reacting at least a portion of the carbon dioxide with secondary amines in the presence of water to form an ammonium bicarbonate salt.

In some embodiments, the functional nanofibers comprise a polymer composition coated with a polyamine polymer selected from the group consisting of: a linear polyethyleneimine, a branched polyethyleneimine, an ethoxylated polyethyleneimine, polypropyleneimine, a polyallylamine, a poly(diallylamine), an ethoxylated polyallylamine, a polysilazane, and combinations thereof.

In some embodiments, the functional nanofibers comprise a melt-blown polymer selected from the group consisting of: polyethylene, polypropylene, polyethyleneterephthalate, polybutyleneterephthalate, polystyrene, polyvinyl chloride, polycarbonate, polyamide, polysulfone, a fluoropolymer, a copolymer thereof, and combinations thereof.

In some embodiments, the functional nanofibers comprise an electrospun polymer selected from the group consisting of: polyacrylonitrile, polyethyleneterephthalate, polybutyleneterephthalate, polystyrene, polystyrene-co-maleic anhydride, polyethylene-co-maleic anhydride, a copolymer thereof, cross-linked polyacrylic acid, cross-linked polyvinylpyrrolidone, cross-linked polyvinylalcohol, and combinations thereof.

The present invention is also directed to a method of separating an oil from a composition. In some embodiments, the method comprises contacting a composition comprising an oil with a filter that includes functional nanofibers having a plurality of hydrophilic functional groups on a surface thereof. In some embodiments, the functional nanofibers have an average cross-sectional dimension of 50 nm to 100 μm. In some embodiments, the method comprises passing a non-oil portion of the composition through the filter to provide the oil on a surface of the filter.

In some embodiments, the functional nanofibers comprise a hydrophilic functional group selected from the group consisting of: hydroxy, alkoxy, thio, thioalkyl, silyl, alkylsilyl, alkylsilenyl, siloxy, primary amino, secondary amino, tertiary amino, ammonium, carboxy, carbonyl, alkylcarbonyl, aminocarbonyl, carbonylamino, sulfonate, sulfate, phosphonic acid, boronic acid, ethylene glycol, a carbohydrate, a metal, a deoxyribonucleic acid, a ribonucleic acid, and combinations thereof.

In some embodiments, the functional nanofibers have an average cross-sectional dimension of 50 nm to 1 μm.

The present invention is also directed to a water-proof, breathable composition comprising a mat of non-woven polymer nanofibers having an inner surface and an outer surface. At least the outer surface of the mat is hydrophobic, and the nanofibers have a mean diameter of about 50 nm to about 1 μm, and 90% or more of the nanofibers have a diameter of 1 μm or less. The mat is permeable to a gas.

The present invention is also directed to a method of separating a liquid from a gas. In some embodiments, the method comprises contacting a surface of a mat of non-woven polymer nanofibers of the present invention with a flowing gas-liquid composition. A gas portion of the gas-liquid composition passes through the mat and a liquid portion of the gas-liquid composition is repelled by a surface of the mat.

In some embodiments, a method comprises collecting the liquid portion of the gas-liquid composition that is repelled by a surface of the mat.

In some embodiments, the polymer nanofibers comprise a polymer selected from: a polyolefin, a polyester, a fluoropolymer, a polysulfone, a polyurethane, a polysiloxane, and combinations thereof.

In some embodiments, the polymer nanofibers comprise a polyolefin selected from the group consisting of: polyethylene, polypropylene, polystyrene, polyvinyl chloride, and combinations thereof.

In some embodiments, the polymer nanofibers comprise a fluoropolymer selected from the group consisting of: polytetrafluoroethylene, a perfluoropolyether, a perfluoroalkoxy polymer, a fluorinated ethylene propylene polymer, an ethylene tetrafluoroethylene copolymer, polyvinyl fluoride, polyvinylidene fluoride, ethylene chlorotrifluoroethylene, and combinations thereof.

In some embodiments, the polymer nanofibers comprise a functional group selected from the group consisting of: alkoxy, alkylthio, siloxy, silyl, alkylsilyl, alkylsilenyl, secondary amino, tertiary amino, alkylcarbonyl, alkylenedioxy, halo, perhalo, and combinations thereof.

When used as a membrane or material, a mat of the functional nanofibers can effectively block water from penetrating the nanofiber mat, while allowing gases to readily pass through the mat. Alternatively, when used as a filter, the functional nanofibers can be derivatized with reactive functional groups to effectively capture a variety of chemical species, in particular carbon dioxide.

Further embodiments, features, and advantages of the present inventions, as well as the structure and operation of the various embodiments of the present invention, are described in detail below with reference to the accompanying drawings.

### BRIEF DESCRIPTION OF THE DRAWINGS

The accompanying drawings, which are incorporated herein and form a part of the specification, illustrate one or more embodiments of the present invention and, together with the description, further serve to explain the principles of the invention and to enable a person skilled in the pertinent art to make and use the invention.

FIGS. 1A and 1B provide a cross-sectional schematic representation of an extruder die suitable for making the nanofibers of the present invention.

FIG. 2 provides a three-dimensional cross-sectional schematic representation of an extruder die suitable for making the nanofibers of the present invention.

FIG. 3 provides a side-view schematic representation of an extruder die suitable for making the nanofibers of the present invention.

FIGS. 4 and 5 provides an image of water containing methylene blue dye on a surface of a nanofiber mat of the present invention.

FIG. 6 provides an image of a separation of oil from water using a functional nanofiber mat of the present invention.

FIG. 7 provides a graphic representation of weight gain versus time for a functional nanofiber mat of the present invention upon exposure to CO₂.

FIG. 8 provides an image of a separation of water from oil using a functional nanofiber mat of the present invention.

One or more embodiments of the present invention will now be described with reference to the accompanying drawing. In the drawing, like reference numbers can indicate identical or functionally similar elements.

### DETAILED DESCRIPTION OF THE INVENTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment,” “an embodiment,” “an example embodiment,” etc., indicate that the embodiment(s) described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

References to spatial descriptions (e.g., “above,” “below,” “up,” “down,” “top,” “bottom,” etc.) made herein are for purposes of description and illustration only, and should be interpreted as non-limiting upon the melt-blown compositions, mats, battery separators, filters, methods, and products of any method of the present invention, which can be spatially arranged in any orientation or manner.

### Functional Nanofibers

The present invention provides functional nanofibers, methods to prepare the nanofibers, and products prepared therefrom. As used herein, a “nanofibers” refers to an elongated structures (or other material described herein) that include at least one cross sectional dimension of 50 nm to 100 μm, and has an aspect ratio (length:width) of 5 or more, 10 or more, 50 or more, 100 or more, or 1,000 or more. As used herein, the term “nanofiber” is interchangeable with the terms “nanowire,” “nanorod,” “nanotube,” “nanoribbon,” and the like. Thus, nanofibers for use with the present invention are not limited to objects having a tubular or cylindrical shape, but can also include nanofibers, tubes, and/or cylinders having a circular, ellipsoidal or irregular cross section, as well as cones, rods, ribbons, and the like.

As used herein, an “aspect ratio” is the length of a first axis of a nanofiber divided by the average of the lengths of the second and third axes of the nanofiber, where the second and third axes are the two axes whose lengths are most nearly equal to each other. For example, the aspect ratio for a perfect rod would be the length of its long axis divided by the diameter of a cross-section perpendicular to (normal to) the long axis.

In some embodiments, a nanofiber or a mat of nanofibers is porous. As used herein, “porous” and “porosity” are interchangeable and refer to a structure comprising void spaces.

The functional nanofibers have a cross-sectional dimension of 50 nm to 100 μm, 50 nm to 50 μm, 50 nm to 25 μm, 50 nm to 10 μm, 50 nm to 5 μm, 50 nm to 1 μm, 50 nm to 750 nm, 50 nm to 500 nm, 50 nm to 250 nm, 100 nm to 100 μm, 100 nm to 50 μm, 100 nm to 25 μm, 100 nm to 10 μm, 100 nm to 5 μm, 100 nm to 2 μm, 100 nm to 1 μm, 100 nm to 750 nm, 100 nm to 500 nm, 200 nm to 100 μm, 200 nm to 50 μm, 200 nm to 25 μm, 200 nm to 10 μm, 200 nm to 5 μm, 200 nm to 1 μm, 200 nm to 750 nm, 20 nm to 600 nm, 200 nm to 500 nm, 250 nm to 750 nm, 250 nm to 600 nm, 300 nm to 800 nm, 300 nm to 600 nm, 500 nm to 100 μm, 500 nm to 50 μm, 500 nm to 25 μm, 500 nm to 10 μm, 500 nm to 5 μm, 500 nm to 1 μm, 600 nm to 1 μm, 600 nm to 800 nm, 750 nm to 5 μm, 750 nm to 2.5 μm, 1 μm to 100 μm, 1 μm to 75 μm, 1 μm to 50 μm, 1 μm to 25 μm, 1 μm to 10 μm, 10 μm to 100 μm, 10 μm to 75 μm, 10 μm to 50 μm, 10 μm to 25 μm, 25 μm to 100 μm, or 50 μm to 100 μm.

Nanofibers for use with the present invention can be rigid or flexible. In some embodiments, a nanofiber can undergo plastic or elastic deformation.

In some embodiments, a mat of functional nanofibers has a surface area of 5 m²/g or greater, or 5 m²/g to 50 m²/g, 5 m²/g to 25 m²/g, 5 m²/g to 10 m²/g, 10 m²/g to 50 m²/g, 10 m²/g to 30 m²/g, 10 m²/g to 20 m²/g, 25 m²/g to 50 m²/g, or 30 m²/g to 50 m²/g.

In some embodiments, a mat of functional nanofibers has a surface area of 15 m²/cm³ or greater, 20 m²/cm³ or greater, 25 m²/cm³ or greater, 50 m²/cm³ or greater, or 75 m²/cm³ or greater.

In some embodiments, a mat of functional nanofibers has a maximum pore size of 30 μm or less, 25 μm or less, 20 μm or less, 15 μm or less, 10 μm or less, 5 μm or less, 2 μm or less, or 1 μm or less.

In some embodiments, a mat of functional nanofibers has a wet:dry ratio (by weight) of about 5, about 10, about 15, about 20, or about 25. In some embodiments, a mat of functional nanofibers has a wet:dry ratio (by weight) of 5 to 25, 5 to 20, 5 to 15, 5 to 10, 10 to 25, 10 to 20, 15 to 25, or 20 to 25.

In some embodiments, a mat of functional nanofibers has a break point of 1 MPa or more, 1.5 MPa or more, 2 MPa or more, 2.5 MPa or more, or 3 MPa or more. In some embodiments, a mat of functional nanofibers has a break point of 1 MPa to 4 MPa, 1 MPa to 3 MPa, or 2 MPa to 4 MPa.

The basis weight (or fabric weight) of a mat of functional nanofibers can vary depending on the requirements of the application. In some embodiments, a mat of functional nanofibers has a fabric weight of 10 g/m² to 100 g/m², or 100 g/m² to 500 g/m². In some embodiments, a mat of functional nanofibers has a fabric weight of 10 g/m² to 75 g/m², 10 g/m² to 50 g/m², 10 g/m² to 25 g/m², 25 g/m² to 100 g/m², 25 g/m² to 75 g/m², or 50 g/m² to 100 g/m². In some embodiments, a mat of functional nanofibers has a fabric weight of 100 g/m² to 400 g/m², 100 g/m² to 300 g/m², 200 g/m² to 500 g/m², or 300 g/m² to 500 g/m².

The functional nanofibers of the present invention comprise a polymer. Polymers suitable for use with the functional nanofibers include thermoplastic polymers, as well as polymers and polymer compositions that can be dissolved in a solvent. Polymers suitable for use in the nanofibers include, but are not limited to, polyolefins, polyesters, fluoropolymers, polysulfones, polyurethanes, and the like, and combinations thereof.

In some embodiments, a polymer for use in the functional nanofibers has an average molecular weight of about 100 kDa to about 500 kDa. In some embodiments, a polymer has a molecular weight distribution of 50,000 Da or less, 25,000 Da or less, or 10,000 Da or less.

Representative polyolefins include, but are not limited to, polyethylene, polypropylene, polyethyleneterephthalate, polybutyleneterephthalate, polystyrene, polyvinyl chloride, and combinations thereof.

Representative fluoropolymers include, but are not limited to, polytetrafluoroethylene, a perfluoropolyether, a perfluoroalkoxy polymer, a fluorinated ethylene propylene polymer, an ethylene tetrafluoroethylene copolymer, polyvinyl fluoride, polyvinylidene fluoride, ethylene chlorotrifluoroethylene, and combinations thereof.

Additional representative polymers for use in the nanofibers of the present invention include, but are not limited to, polycarbonate, polyamide (e.g., nylon 6,6, nylon 6,11, nylon 5,10, nylon 9, and the like), polyacrylonitrile, polyacrylic acid, polyvinylpyrrolidone, polyvinylalcohol, polyethyleneterephthalate, polybutyleneterephthalate, polystyrene-co-maleic anhydride, polyethylene-co-maleic anhydride, a copolymer thereof, and combinations thereof.

In some embodiments, the nanofibers are functionalized. As used herein, “functionalized” and “derivatized” are used interchangeably and refer to the attachment of a chemical group, ligand, species, moiety, and the like to a nanofiber. In some embodiments, nanofibers are derivatized with a molecular species as described herein, or an oligomer, a dendrimer, a polymer, a nanoparticle, or a metal complex thereof, wherein a molecular species is present as a repeat unit in an oligomer, dendrimer, polymer, or nanoparticle, or as a ligand in a metal complex.

Not being bound by any particular theory, functionalization can be achieved via a covalent bonding interaction, an ionic bonding interaction, a hydrogen bonding interaction, a non-bonding interaction, an intercalation interaction, physical entanglement, a chiral interaction, a magnetic interaction, and combinations thereof. Derivatization and functionalization can be performed to repel a chemical, capture a chemical, increase the hydrophobicity of a nanofiber mat, increase the hydrophilicity of a nanofiber mat, and combinations thereof.

In some embodiments, a portion of the nanofibers present in a mat are not functionalized and/or derivatized.

In some embodiments, at least a portion of a nanofiber surface is functionalized with one of the following groups to facilitate an association with a substrate, a backing material or scaffold, and/or a chemical species: hydroxy, alkoxy, thio, alkylthio, silyl, alkylsilyl, alkylsilenyl, siloxy, primary amino, secondary amino, tertiary amino, carbonyl, alkylcarbonyl, aminocarbonyl, carbonylamino, carboxy, and the like, and combinations thereof.

In some embodiments, a functional nanofiber comprises one or more hydrophobic functional groups covalently attached to at least a surface of the nanofiber. As used herein, “hydrophobic” refers to functional groups that, when attached to a nanofiber, enable a mat of nanofibers to repel water, resist penetration of water and/or result in a surface that cannot be wetted by water. For example, in some embodiments water deposited on a mat of hydrophobic nanofibers of the present invention forms a droplet having a contact angle of 90° to 180°. In some embodiments, water deposited onto a hydrophobic coating of the present invention forms a minimum contact angle of about 90°, about 100°, about 110°, about 120°, about 130°, about 140°, about 150°, or about 160°.

Hydrophobic functional groups include halo groups, optionally substituted C₁-C₃₀ alkyl, optionally substituted C₂-C₃₀ alkenyl, optionally substituted C₂-C₃₀ alkynyl, optionally substituted C₆-C₃₀ aryl, optionally substituted C₆-C₃₀ aralkyl, optionally substituted C₆-C₃₀ heteroaryl, and combinations thereof, wherein these groups can be linear or branched. Optional substituents for hydrophobic functional groups include, but are not limited to, halo and perhalo (i.e., wherein halo is any one of: fluorine, chlorine, bromine, iodine, and combinations thereof), alkylsilyl, siloxy, tertiary amino, and combinations thereof. In some embodiments, an optionally substituted hydrophobic molecular species is selected from: fluoro, a C₁-C₃₀ fluoroalkyl, a C₁-C₃₀ perfluoroalkyl, and combinations thereof.

Functional groups suitable for imparting hydrophilicity to a nanofiber include, but are not limited to, hydroxy, alkoxy, thio, thioalkyl, silyl, alkylsilyl, alkylsilenyl, siloxy, primary amino, secondary amino, tertiary amino, ammonium, carboxy, carbonyl, alkylcarbonyl, aminocarbonyl, carbonylamino, sulfonate, sulfate, phosphonic acid, boronic acid, ethylene glycol, a carbohydrate, a metal, a deoxyribonucleic acid, a ribonucleic acid, and the like, and combinations thereof.

Not being bound by any particular theory, alkylsilyl, alkylsilenyl, siloxy, primary amino, secondary amino, tertiary amino, alkylcarbonyl, aminocarbonyl, carbonylamino, and carboxy functional groups can also impart hydrophobicity to a surface depending on the presence and length of an —R group attached to the functional group, wherein R is, e.g., alkyl, alkenyl, alkynyl, and the like, wherein increasing the number of carbon atoms present in R increases the hydrophobicity of a coating layer.

In some embodiments, a functional nanofiber comprises one or more hydrophilic functional groups. As used herein, “hydrophilic” refers to functional groups that, when attached to a nanofiber, enable a mat of nanofibers to repel an oil, resist penetration of an oil into a nanofiber mat, or result in a surface that cannot be wetted by an oil.

As used herein, an “oil” refers to a substance that is a liquid at, e.g., 25° C. and is soluble in an organic solvent such as, but not limited to, hexanes, benzene, toluene, and the like. Representative oils include, but are not limited to, vegetable oils, petrochemicals, essential oils, and the like. Some heavy oils are waxy or semi-solid at room temperature, but behave like an oil when heated and are thus also within the scope of the present invention.

Hydrophilic functional groups include, but are not limited to, hydroxy, thio, primary amino, carboxy, carbonyl, aminocarbonyl, carbonylamino, and the like, and combinations thereof.

As used herein, “alkyl,” by itself or as part of another group, refers to straight and branched chain hydrocarbons of one to 30 carbon atoms, such as, but not limited to, octyl, decyl, dodecyl, hexadecyl, and octadecyl.

As used herein, “alkenyl,” by itself or as part of another group, refers to a straight and branched chain hydrocarbons of two to 30 carbon atoms, wherein there is at least one double bond between two of the carbon atoms in the chain, and wherein the double bond can be in either of the cis or trans configurations, including, but not limited to, 2-octenyl, 1-dodecenyl, 1-8-hexadecenyl, 8-hexadecenyl, and 1-octadecenyl.

As used herein, “alkynyl,” by itself or as part of another group, refers to straight and branched chain hydrocarbons of two to 30 carbon atoms, wherein there is at least one triple bond between two of the carbon atoms in the chain, including, but not limited to, 1-octynyl and 2-dodecynyl.

As used herein, “aryl,” by itself or as part of another group, refers to cyclic, fused cyclic, and multi-cyclic aromatic hydrocarbons containing six to 30 carbons in the ring portion. Typical examples include phenyl, naphthyl, anthracenyl, and fluorenyl.

As used herein, “aralkyl” or “arylalkyl,” by itself or as part of another group, refers to alkyl groups as defined above having at least one aryl substituent, such as benzyl, phenylethyl, and 2-naphthylmethyl. Similarly, the term “alkylaryl,” as used herein by itself or as part of another group, refers to an aryl group, as defined above, having an alkyl substituent, as defined above.

As used herein, “heteroaryl,” by itself or as part of another group, refers to cyclic, fused cyclic and multicyclic aromatic groups containing five to 30 atoms in the ring portions, wherein the atoms in the ring(s), in addition to carbon, include at least one heteroatom. The term “heteroatom” is used herein to mean an oxygen atom (“0”), a sulfur atom (“S”) or a nitrogen atom (“N”). Additionally, the term heteroaryl also includes N-oxides of heteroaryl species that containing a nitrogen atom in the ring. Typical examples include pyrrolyl, pyridyl, pyridyl N-oxide, thiophenyl, and furanyl.

Any one of the above groups can be further substituted with one or more of the following substituents: hydroxy, alkoxy, thio, alkylthio, silyl, alkylsilyl, alkylsilenyl, siloxy, primary amino, secondary amino, tertiary amino, carbonyl, alkylcarbonyl, aminocarbonyl, carbonylamino, carboxy, halo, perhalo, alkylenedioxy, and combinations thereof.

As used herein, “hydroxy,” by itself or as part of another group, refers to an (—OH) moiety.

As used herein, “alkoxy,” by itself or as part of another group, refers to one or more alkoxyl (—OR) moieties, wherein R is selected from the alkyl, alkenyl, alkynyl, aryl, aralkyl, and heteroaryl groups described above.

As used herein, “thio,” by itself or as part of another group, refers to an (—SH) moiety.

As used herein, “alkylthio,” refers to an (—SR) moieties, wherein R is selected from the alkyl, alkenyl, alkynyl, aryl, aralkyl, and heteroaryl groups described above.

As used herein, “silyl,” by itself or as part of another group, refers to an (—SiH₃) moiety.

As used herein, “alkylsilyl,” by itself or as part of another group, refers to an (—Si(R)ₓH_{y}) moiety, wherein 1≦x≦3 and y=3−x, and wherein R is independently selected from the alkyl, alkenyl, alkynyl, aryl, aralkyl, and heteroaryl groups described above.

As used herein, “alkylsilenyl,” by itself or as part of another group, refers to a (—Si(═R)H) moiety, wherein R is selected from the alkyl, alkenyl, alkynyl, aryl, aralkyl, and heteroaryl groups described above.

As used herein, “siloxy,” by itself or as part of another group, refers to a (—Si(OR)ₓR¹_{y}) moiety, wherein 1≦x≦3 and y=3−x, wherein R and R¹ are independently selected from hydrogen and the alkyl, alkenyl, alkynyl, aryl, aralkyl, and heteroaryl groups described above.

As used herein, “primary amino,” by itself or as part of another group, refers to an (—NH₂) moiety.

As used herein, “secondary amino,” by itself or as part of another group, refers to an (—NRH) moiety, wherein R is selected from the alkyl, alkenyl, alkynyl, aryl, aralkyl, and heteroaryl groups described above.

As used herein, “tertiary amino,” by itself or as part of another group, refers to an (—NRR¹) moiety, wherein R and R¹ are independently selected from the alkyl, alkenyl, alkynyl, aryl, aralkyl, and heteroaryl groups described above.

As used herein, “carbonyl,” by itself or as part of another group, refers to a (C═O) moiety.

As used herein, “alkylcarbonyl,” by itself or as part of another group, refers to a (—C(═O)R) moiety, wherein R is independently selected from hydrogen and the alkyl, alkenyl, alkynyl, aryl, aralkyl, and heteroaryl groups described above.

As used herein, “aminocarbonyl,” by itself or as part of another group, refers to a (—C(═O)NRR¹) moiety, wherein R and R¹ are independently selected from hydrogen and the alkyl, alkenyl, alkynyl, aryl, aralkyl, and heteroaryl groups described above.

As used herein, “carbonylamino,” by itself or as part of another group, refers to a (—N(R)C(═O)R¹) moiety, wherein R and R¹ are independently selected from hydrogen and the alkyl, alkenyl, alkynyl, aryl, aralkyl, and heteroaryl groups described above.

As used herein, “carboxy,” by itself or as part of another group, refers to a (—COOR) moiety, wherein R is independently selected from hydrogen and the alkyl, alkenyl, alkynyl, aryl, aralkyl, and heteroaryl groups described above.

As used herein, “alkylenedioxy,” by itself or as part of another group, refers to a ring and is especially C₁₋₄ alkylenedioxy. Alkylenedioxy groups can optionally be substituted with halogen (especially fluorine). Typical examples include methylenedioxy (—OCH₂O—) or difluoromethylenedioxy (—OCF₂O—).

As used herein, “halo,” by itself or as part of another group, refers to any of the above alkyl, alkenyl, alkynyl, aryl, aralkyl, and heteroaryl groups wherein one or more hydrogens thereof are substituted by one or more fluorine, chlorine, bromine, or iodine atoms.

As used herein, “perhalo,” by itself or as part of another group, refers to any of the above alkyl, alkenyl, alkynyl, aryl, aralkyl, and heteroaryl groups wherein all of the hydrogens thereof are substituted by fluorine, chlorine, bromine, or iodine atoms. In some preferred embodiments, a nanofiber mat for use as a water-proof, breathable composition of the present invention has a fluorinated surface. In some embodiments, at least an outer surface of a nanoflber mat is fluorinated (e.g., by exposure to F₂, SiF₄, SF₆, a fluorinated alkyl and/or alkoxy silane, and the like, as well as other fluorination processes that would be apparent to a person of ordinary skill in the art of surface fluorination) to provide a fluorinated surface.

In particular, nanofiber mats functionalized with groups selective for metal binding such as, but not limited to, amine, carboxy, thio, hydroxy, and the like, can be useful for separating metals and metal ions from solid and/or liquid mixtures (e.g., waste streams, ore, exhaust, and the like).

Various other compositions and/or chemical treatments are useful to render the functional nanofibers hydrophilic. In some embodiments, a functional nanofiber comprises a conformal metal oxide layer coating at least a portion of the nanofibers.

Metal oxide suitable for coating the functional nanofibers include, but are not limited to, silica (SiₓO_{y}), titania (TiₓO_{y}), alumina (Al_{y}O_{z}), zirconia (ZrₓO_{y}), boron oxide (B_{y}O_{z}), germania (GeₓO_{y}), hydrides thereof, alkoxides thereof, organo-substituted variants thereof, hydrates thereof, and the like, and combinations thereof (wherein x is 0.5 to 1, y is 1 to 2, and z is 2 to 3).

In some embodiments, a conformal metal oxide layer has a thickness of 2 nm to 500 nm, 2 nm to 400 nm, 2 nm to 300 nm, 2 nm to 250 nm, 2 nm to 200 nm, 2 nm to 150 nm, 2 nm to 100 nm, 2 nm to 75 nm, 2 nm to 50 nm, 2 nm to 25 nm, 2 nm to 20 nm, 2 nm to 15 nm, or 2 nm to 10 nm.

The functional nanofibers of the present invention can be prepared by sol-gel methods. In some embodiments, a sol-gel method for derivatizing the functional nanofibers comprises suspending a nanofibers in a solvent, contacting a metal oxide precursor with the suspended nanofibers for a time sufficient to form a metal oxide thin film on the surface of the nanofibers, and optionally curing the metal oxide thin film (e.g., thermochemical curing) to fully cross-link the thin film and remove any residual solvent.

The nanofibers can be suspended in an alcoholic solution (e.g., methanol, ethanol, 2-propanol, and the like) comprising a metal oxide precursor, an acid, and water. Typical reaction times are about 1 hour to about 48 hours, about 2 hours to about 36 hours, about 4 hours to about 24 hours, or about 6 hours to about 18 hours. Heating the solution at about 30° C. to about 70° C. can speed up the reaction. Unreacted metal oxide precursor stays in the solution.

In some embodiments, the nanofibers are derivatized with hydroxy groups (e.g., by exposing the fibers to UV light, ozone, oxygen plasma, a corona discharge, heat treatment, and the like) prior to suspension in a metal oxide precursor solution.

Metal oxide precursors suitable for use with the present invention include, but are not limited to, a metal alkoxide, a metal hydroxide, an alkoxy-metal hydroxide, an alkoxy-metal hydride, and combinations thereof. Metals suitable for use in the precursors include, but are not limited to, silicon, titanium, zirconium, boron, germanium, gallium, and the like, and combinations thereof.

In some embodiments, a nanofiber is coated with a polymer, such as a polymer comprising a plurality of amine groups (a “polyamine polymer”). Representative polyamine polymers include, but are not limited to, a linear polyethyleneimine, a branched polyethyleneimine, an ethoxylated polyethyleneimine, polypropyleneimine, a polyallylamine, a poly(diallylamine), an ethoxylated polyallylamine, a polysilazane, and combinations thereof. Representative structures of several of these polymers are provided in the following Table.

| Polyamine Polymer | Representative Chemical Structure |
|---|---|
| Linear-polyethyleneimine | 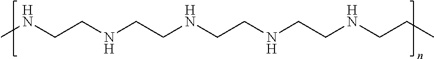 |
| Branched-polyethyleneimine | 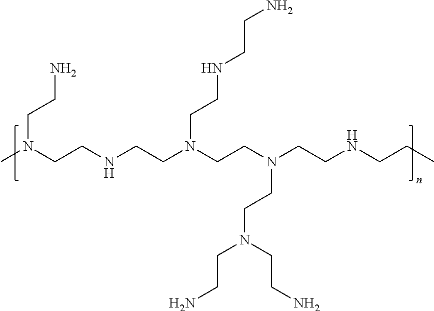 |
| Ethoxylated-polyethyleneimine | 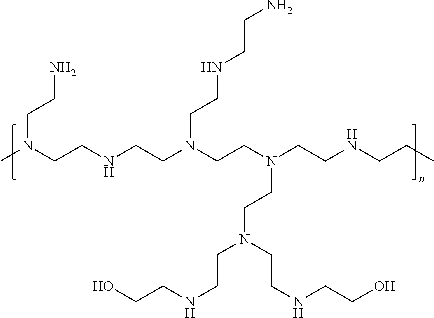 |
| Polyallylamine | 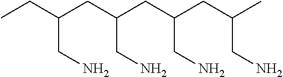 |
| Ethoxylated polyallylamine | 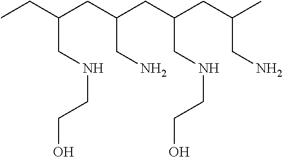 |

In some embodiments, a polyamine polymer has a molecular weight of 500 Da to 1,000 kDa. In some embodiments, a polyamine polymer has a molecular weight of 50 kDa to 500 kDa.

In some embodiments, a polyamine polymer comprises secondary amines. In some embodiments, at least 20%, at least 25%, at least 33%, at least 40%, at least 50%, at least 60%, at least 67%, or at least 75% of the amine groups present in the polymer are secondary amines.

In particular, sterically hindered amines having a hydroxy groups 2-3 carbons from the amine nitrogen, such as ethoxylate, 2-piperidinemethanol, diisopropanolamine and 3-piperidino-1,2-propanediol, and the like, are useful.

In some embodiments, the functional nanofibers include an additive such as a surfactant suitable to facilitate coating of the nanofibers. In particular, functional nanofibers that include a conformal metal oxide layer and/or a polymer coating on the nanofibers can include a surfactant in a concentration (e.g., 0.1% to about 20%) suitable to render the nanofibers wettable by a coating precursor.

Surfactants suitable for adding to the nanofibers include, but are not limited to, a polyethylene or polypropylene portion of 4 to 20 units with a hydrophilic, non-ionic head group; a polyethylene or polypropylene portion of 4 to 20 units linked to a hydrophilic, ionic head group (e.g., sodium dodecyl sulfate, and the like); a polyethylene glycol portion of 1 to 10 units linked to a hydrophobic head group (e.g., TRITON® X-100, Rohm & Haas Co., Philadelphia, Pa., and the like); a block copolymer of ethylene and ethylene oxide (e.g., BRIJ® 93, Uniqema Americas LLC, Wilmington, Del., and the like); a block copolymer of a perfluoropolyethylene or perfluoropolypropylene and a polyethylene glycol (e.g., ZONYL® FSO and/or ZONYL® FSN, E.I. DuPont de Nemours & Co., Wilmington, Del., and the like); a triblock copolymer of ethylene oxide and propylene oxide (e.g., PLURONIC® P104 and/or PLURONIC® F127, BASF Corp., Mount Olive, N.J., and the like); a poly(perfluoropropylene glycol) carboxylate; a block copolymer of a perfluoropolyether and polyethylene glycol (e.g., ZONYL® 7950, E.I. DuPont de Nemours & Co., Wilmington, Del., and the like); a block copolymer of ethylene and acrylic acid; a polysiloxane having alkyl and ethylene oxide side groups; IRGASURF® SR 100 (CIBA® Specialty Chemicals, Corp., Tarrytown, N.Y.), IRGASURF® HL 560 (CIBA® Specialty Chemicals, Corp., Tarrytown, N.Y.); and the like; and combinations thereof.

The functional nanofibers and non-woven mats thereof can be characterized using standard analytical tools and procedures known to persons of ordinary skill in the art.

### Methods of Making the Functional Nanofibers

The functional nanofibers can be formed using a melt-blowing apparatus. The apparatus includes a pressurized, heated extruder die having a series of small orifices at the front edge of an air knife through which a plurality of filaments of molten thermoplastic polymer are extruded. The extruder die also uses heated and pressurized air flowing in the direction of extrusion to attenuate the molten polymer upon exit from the orifices. A polymeric feed is added to a single screw extruder where it is melted and extruded to a meltblowing die. Hot air (usually 10° C. to 50° C. hotter than the molten polymer is used to drive the air knife, and this air is accelerated past the openings in the dies at 200-400 mph. This stream of hot air accelerates the extruding polymer away from the die at a very rapid speed, elongating it and creating very fine nanofibers. The nanofibers are continuously deposited on a moving conveyor to form a consolidated flat web of desired thickness, which may be cut into the desired shape.

In some embodiments, the melt-blown nanofiber compositions for use with the present invention can be prepared using conventional means, and the design and operation are well within the ability of those skilled in the art. For example, suitable apparatus and methods are described in U.S. Pat. Nos. 3,849,241 and 3,972,759, which are incorporated herein by reference in their entirety.

Not being bound by any particular theory, process parameters that can affect the degree of porosity, mat surface area, and/or nanofiber morphology for melt-blown nanofibers include the air temperature at the die, the difference between the air temperature at the extruder die and the ambient air temperature (i.e., the air temperature at the collector), the die-to-collector distance, the utilization rate, and the collector speed. On one hand, a large difference in air temperature between the extruder die and the collector results in rapid cooling of the nanofibers, which provides finer crystalline domains in the nanofibers and lower mechanical strength in the mat. On the other hand, if the difference in air temperature between the extruder die and collector is too small, then the nanofibers can coalesce prior to cooling, resulting in larger fiber diameter and lower surface area. Generally, the process can be varied according to the values in the following Table.

TABLE
Process parameters for preparing melt-blown nanofiber mats
of the present invention.

| Parameter | Value |
|---|---|
| Ambient Air Temperature | 100° C.-400° C. |
| Extruder Die Zone 2 Temperature | 100° C.-400° C. |
| Extruder Die Zone 3 Temperature | 100° C.-400° C. |
| Extruder Die Zone 4 Temperature | 100° C.-400° C. |
| Air Temperature at Die | 200° C.-400° C. |
| Extruder Current | 1 amps-10 amps |
| Hole Size | 0.002 in-0.015 in. |
| Collector Speed | 0.5 m/min-20 m/min |
| Air Pressure | 5 psi-50 psi |
| Extruder Die Pressure | <200 psi |
| Extruder Die-to-Collector Distance | 100 mm-1,000 mm |
| Throughput | 0.1 g/hole/min-1 g/hole/min |

Polymers suitable for melt-blowing include, but are not limited to, polyethylene, polypropylene, polyethyleneterephthalate, polybutyleneterephthalate, polystyrene, polyvinyl chloride, polycarbonate, a polyamide, a polysulfone, a fluoropolymer, and the like, and combinations thereof.

From these considerations, a person skilled in the art will be able to prepare a melt-blown mat of uniform thickness. In general, nanofibers present in a mat have an mean diameter of 50 nm to 100 μm. The average fiber diameter can be selected based on equipment used for the extruding and process conditions. In some embodiments, as the diameter of the holes in the extruder die is decreased, the fiber diameter will also be decreased. Not being bound by any particular theory, uniformity of the nanofibers can be maintained by using a monodisperse polymer precursor, a substantially homogeneous melt mixture, a uniform pressure profile of the melt mixture on the backside of the extruder die, and having a uniform air pressure and air flow profile surrounding the extruder die and the laminar zone away from the die.

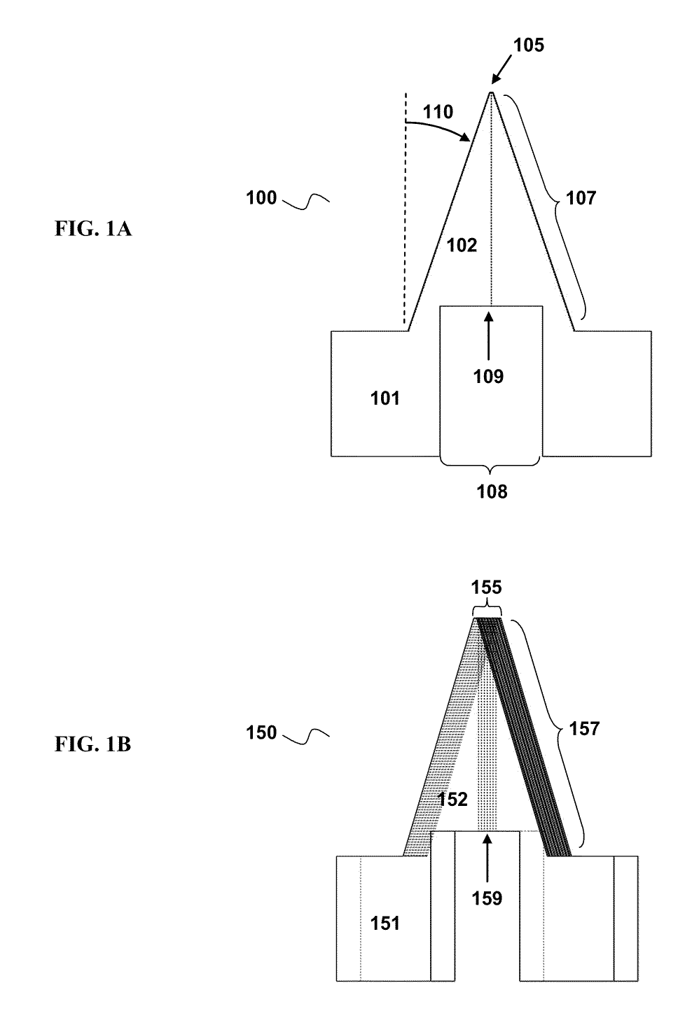

FIGS. 1A and 1B provide a cross-sectional schematic representations of an extruder die suitable for preparing nanofibers. Referring to FIG. 1A, an extruder die, 100, comprises a base, 101, having a cavity therein, 108, and a tip portion, 102, having a plurality of holes there through, 109, the holes ending in a plurality of openings, 105. The tip portion, 102, includes angular side-walls, 107, that form an angle, 110 with the base. The sidewall angle can be varied, with a sidewall angle of about 20° to about 40° being preferred. In some embodiments, the extruder die is a monolithic structure.

Referring to FIG. 1B, a three-dimensional cross-sectional schematic of an extruder die, 150, is provided. In particular, the plurality of holes, 159, passing through the tip portion, 152, can be seen, the holes terminating in a plurality of openings, 155. The sidewalls, 157, comprise a flat face having a plurality of grooves therein. (and depicted in further detail below).

Generally, an extruder die is formed from a rigid material that is able to withstand significant pressure applied the backside of the extruder die during melt-blowing. In addition, materials should have a low coefficient of thermal expansion. Suitable materials include metals, ceramics, and the like, with stainless steel being preferred.

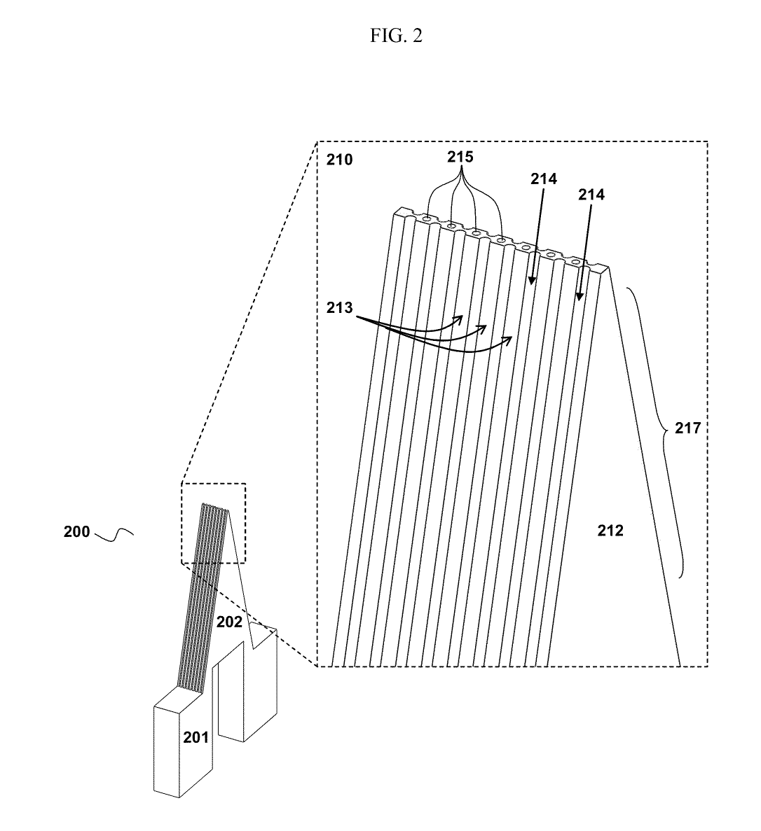

FIG. 2 provides a three-dimensional schematic representation of an extruder die suitable for making the nanofibers of the present invention. Referring to FIG. 2, the extruder die, 200, includes a base portion, 201, and a tip portion, 202. An inset, 210, depicts an enlargement of the tip portion. The sidewalls, 217, of the tip portion, 212, include a flat face, 213, having a plurality of grooves, 214, therein. While curved grooves are depicted, other shapes are also suitable, including trigonal grooves, square grooves (as well as other rectilinear shapes), half-hexagonal grooves, and the like. The depth of the grooves can be varied. The holes in the tip portion terminate in a plurality of openings in the, 215. The size of the holes and the openings in the tip portion of the extruder die can be varied. In some embodiments, the holes and openings have a diameter of about 0.002 in to about 0.010 in. (i.e., about 50 μm to about 250 μm). In some embodiments, the holes and openings have a diameter of about 100 μm to about 200 μm, about 100 μm, about 150 μm, or about 200 μm. In some embodiments, the openings have a diameter that is less than or greater than the diameter of the holes.

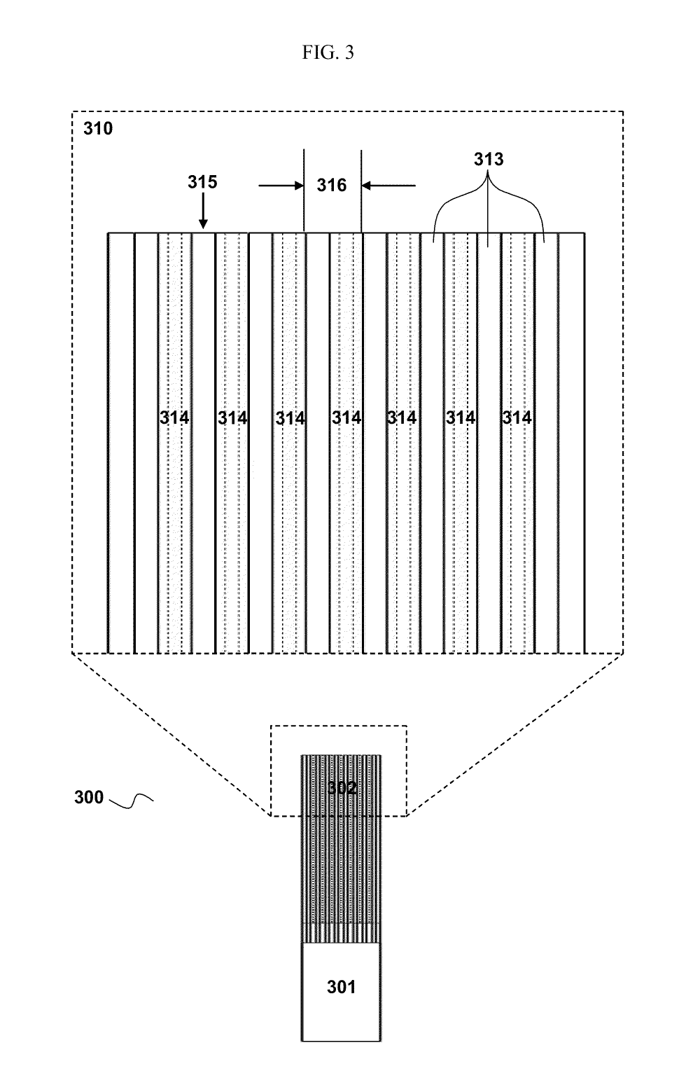

FIG. 3 provides a side-view representation of an extruder die suitable for making the nanofibers of the present invention. Referring to FIG. 3, the extruder die, 300, comprises a base portion, 301, and a tip portion, 302. An inset, 310, depicts an enlargement of the tip portion. The sidewalls of the tip portion include a flat face, 313, having a plurality of grooves, 314, therein. The holes in the tip portion terminate in a plurality of openings in the, 315. The spacing, 316, of the holes is typically periodic, with a pitch of about 200 μm to about 500 μm, about 300 μm to about 400 μm, about 300 μm, or about 350 μm. Patterns of holes or irregularly spaced holes can also be utilized depending on the application.

In addition to the melt-blowing processes described herein, the water-proof, breathable mats can also be prepared by a process of electrospinning or melt-electrospinning.

In electrospinning a viscous solution is dispensed through a spinneret (often a blunt 20 gauge to 30 gauge needle), which is connected to a high-voltage power supply at a fixed distance from a grounded collector. A DC bias of 10 kV to 30 kV is to the spinneret using the power supply. The high voltage distorts the shape of the expelled droplet, elongating it into a cone (i.e., a Taylor cone). Eventually, electrostatic repulsion causes the solution to be expelled from the tip of the cone as an electrified liquid jet that is accelerated towards a collector. After being expelled from the tip the liquid jet rapidly solidifies by solvent evaporation and/or reactions within the solution (depending upon the composition of the precursor solution). Simultaneously, the jet is elongated until it reaches nanoscale dimensions. Deposition of the elongated nanofibers at the collector provides a non-woven mat of continuous nanofibers.

Fibers with diameters of 1 μm or less are readily obtained from a wide range of polymers and materials. Specifically, electrospinning can be used to fabricate polymer nanofibers from practically any polymer that can be dissolved in an appropriate solvent. Polymers suitable for use with melt-blowing include, but are not limited to, polyacrylonitrile, polyethyleneterephthalate, polybutyleneterephthalate, polystyrene, polystyrene-co-maleic anhydride, polyethylene-co-maleic anhydride, a copolymer thereof, and combinations thereof. Additional polymers suitable electrospinning include water-soluble polymers such as polyacrylic acid, polyvinylpyrrolidone, polyvinylalcohol, and the like that are electrospun and subsequently cross-linked via a post-deposition process.

Core-sheath nanofibers can be deposited by co-spinning two immiscible materials using a co-axial spinneret. Hollow nanofibers can be produced by adding an immiscible solvent or polymer to the spinning solution, which deposits in the core of a resulting nanofiber and is selectively removed, for example, via dissolution, oxidation, and the like. nanofibers decorated with nanoparticles can be readily prepared using a polymer solution in the core and a particle dispersion in the sheath. In addition, co-axial electrospinning can provide nonwoven nanofiber mats for CO₂ absorption. For example, a core solution comprising a polyester can be co-spun with a sheath solution comprising a polyamine and a cross-linker to provide a mat of core-sheath nanofibers suitable for CO₂ absorption.

Furthermore, the composition and surface morphology of the nanofibers can be modified using post-deposition processes. For example, carbon nanofibers can be provided by carbonizing polyacrylonitrile nanofibers in an inert atmosphere (e.g., N₂ or Ar).

In addition, polymer coatings (e.g., polyamine polymer coatings) can be applied to a nanofiber surface to form a durable coating on the nanofibers. In some embodiments, prior to coating with a polymer or prior to being functionalized the nanofibers are rendered hydrophilic. For example, a nanofiber can be treated with an oxygen plasma, corona discharge, ozone, UV light, an acid, a surfactant, and the like, and combinations thereof, in order to provide a hydrophilic surface. A hydrophilic surface is readily wetted by a solution comprising a polyamine polymer (e.g., a water/ethanol solution). Sufficient wetting is critical for the formation of a homogeneous conformal coating.

If necessary, an adhesion promoter (e.g., an amino-derivatized alkoxysilane) can be applied to the hydrophilic nanofibers. Particularly useful for coating nanofibers with polyamine polymers are adhesion promotes that include a first group capable of reacting with a hydroxy and/or a carbon-carbon bond, and a second group such as epoxide, bromide, isocyanate, and the like, which is capable of reacting with an amine.

Cross-linking of the polymer coating is important for providing a durable coating on the nanofiber surface. Crosslinker groups suitable for use with the present invention include, but are not limited to, epichlorohydrin, bisepoxides, bisisocyanantes, and the like, and combinations thereof. For example, epichlorohydrin can convert secondary amines to tertiary amines, as provided in the following scheme:

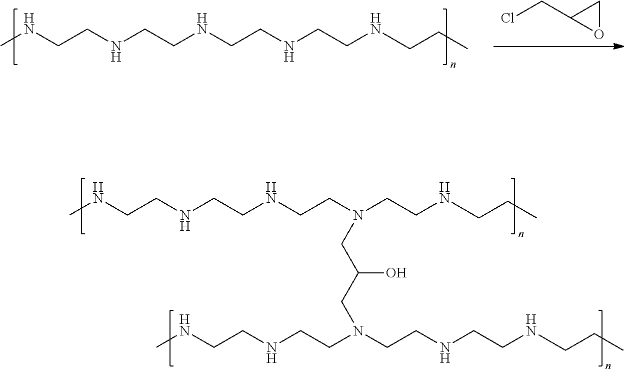

Ethoxylates generated during crosslinking are both robust, and can provide for enhanced CO₂ absorption. Optimized crosslinking density can achieve a balance between durability and accessibility of chemical groups within the polymer coating.

A polymer coating can be applied by dip-coating, spraying, aerosol application, spinning, and the like. Typically, a polyamine polymer coating having a thickness of 10 nm to 10 μm is applied to a nanofiber support. The resulting polyamine nanostructure compositions have a high surface area and undergo rapid, reversible reaction with carbon dioxide.

### Filters and Membranes

The present invention is also directed to a mat of non-woven nanofibers comprising a polymer, wherein the nanofibers have an mean diameter of 50 nm to 100 μm, the mat has a median pore size of about 10 μm or less, and the mat has a porosity of about 60% or greater. The mean fiber diameter, median pore size and porosity can be adjusted within these ranges as described herein.

As used herein, a “filter” refers to a device for separating, capturing, or excluding materials from a gaseous and/or liquid mixture by passing the mixture through the device. A filter can be used to protect downstream systems, equipment and/or personnel from contamination, e.g., by a filtrate. In other cases, a filter can isolate a desired material from a reaction or waste stream.

In some embodiments, a mixture is a gaseous fluid a filter is used to capture or exclude particulates, for use in, e.g., a vehicle (adjacent to an engine, fan, or climate control device), a personal safety device (e.g., a breathing device that prevents inhalation of airborne particulates, viruses and/or pathogens); environmental technology (e.g., for collecting particulate formed during fuming or pyrolysis).

In some embodiments, a filter can be used to isolate: a solid from a liquid and/or gas, a gas from a liquid, a liquid from a liquid (e.g., oil from water or water from an oil), a liquid from a gas and/or a solute from a solvent (e.g., isolation of an ion from a solvent).

The filters of the present invention can be used, for example, in air handling and/or air purification systems (e.g., respirators, air conditioning, exhaust systems, and the like), in water handling and/or water purification systems, in oil purification systems (e.g., oil filters), scrubbers, ion filters, medical equipment (e.g., dialysis equipment, blood filters, biomedical filters, and the like), and industrial/laboratory equipment (e.g., concentrators, filter media for research and manufacturing, and the like).

The present invention is also directed to a water-proof, breathable composition comprising a mat of non-woven, melt-blown polymer nanofibers having an inner surface and an outer surface, wherein at least the outer surface of the mat is hydrophobic, wherein the nanofibers have a mean diameter of 50 nm to 1 μm and 90% or more of the nanofibers have a diameter of 1 μm or less, and wherein the mat is substantially permeable to a gas.

Water-proof, breathable membranes are melt-blown nanofiber mats that are, in one embodiment, essentially impermeable by liquid water but permeable to gases (including water vapor). In some embodiments, the water-proof, breathable membranes are impermeable to other liquids such as blood, saliva, urine, and the like.

Water-proof, breathable membranes can be a component in, for example, outdoor clothing for protection against rain, snow, sleet, hail, and other forms of water including immersion in water (e.g., for use in waders).

As used herein, “breathable” refers to the ability of water vapor and other gases (O₂, N₂, CO₂, Ar, and the like), whether ambient or produced, e.g., via respiration, perspiration, combustion and the like, to permeate, diffuse, or otherwise pass through the membranes. For example, in addition to outdoor clothing, the water-proof, breathable membranes can be used in building materials, personal safety equipment, medical applications (e.g., smocks, scrubs, booties, and the like), and other selective barrier applications. Additional applications for the water-proof, breathable membranes include, but are not limited to, uniforms and outdoor clothing (e.g., jackets, pants, shoes and boots, shoe liners, socks, gloves, hats, and the like), personal protective equipment (e.g., suits and coveralls, smocks, bibs, scrubs, face masks, and the like), building materials (e.g., wraps, and external water barriers for wood, stone, metal, and the like), furniture and upholstery (e.g., covers, beds, couches, chairs, carpeting, and the like), and packaging.

In some embodiments, a filter can be functionalized with an groups that is unreactive towards a desired analyte, but capable of binding other components of a mixture. Such affinity filters can be partially functionalized with alkyl, fluoro and/or fluoroalkyl groups in order to isolate water from an oil-in-water or a water-in-oil emulsion.

Properties of the filters and membranes of the present invention that can be controlled include, but are not limited to, composition, stoichiometry, pore size, wettability, density, chemical stability, and the like.

The filters of the present invention are suitable for filtering liquid, gaseous and/or vapor compositions. For example, the filters of the present invention are suitable for use in cooling systems, heating systems, chemical synthesis and/or purification processes, air filtration systems, automobiles, aircraft, consumer electronics, industrial electronics, military applications, space applications, and any other applications in which filters are required or desirable.

The present invention is also directed to a products and articles of manufacture comprising the functional nanofibers. In some embodiments, an article comprises a plurality of elongated structures as a non-woven mat. A non-woven mat can have a thickness of 10 μm to 10 m. Thus, a mat can be used as a packing material in an exhaust, a smokestack, a filter for use in a recirculating air system, and the like.

In some embodiments, an article is provided as a flow-through device comprising a non-woven mat comprising functional nanofibers as a rechargeable packing material. For example, flow-through devices include columns, scrubbers, filters, converters, piping, and any other system having an inlet and an outlet. In some embodiments, a flow-through device of the present invention is suitable for attachment to at least a portion of an exhaust of an internal combustion engine, an exhaust of a jet engine, an automobile exhaust, a truck exhaust, a motorcycle exhaust, a reactor exhaust, a jet exhaust, a smokestack, a chimney, a kitchen exhaust, a heater exhaust, and the like.

A flow-through device can include a non-woven mat of the present invention as a packing material such as, but not limited to, a plurality of elongated structures, a mat, a non-woven mat, a particulate, a powder, a membrane, a wool, and the like, and combinations thereof.

In some embodiments, a plurality of the functional nanofibers are at least partially fused to provide a monolithic article, for example, a sheet, a membrane, a sponge, and the like.

In some embodiments, an article of the present invention further comprises a component selected from: a filler, a scaffold, a support, a chemical stabilizer, an antioxidant, and the like, and combinations thereof.

The non-woven mats of the present invention are robust and can be used in a wide variety of industrial applications without undergoing physical and/or chemical degradation. As used herein, “robust” refers to physical, dimensional and/or chemical stability. For example, the mats for use with the present invention exhibit wear resistance, dimensional stability, and chemical stability that makes them suitable for use in a wide range of environments.

In some embodiments, a non-woven mat of the present invention has a lifetime of about 5,000 hours or more, about 10,000 hours or more, about 15,000 hours or more, and can be used in an industrial application to filter particles having an average diameter of 100 μm or less, 50 μm or less, 10 μm or less, 5 μm or less, or 1 μm or less.

### Methods of Using the Functional Nanofibers

The present invention is also directed to a method for sequestering carbon dioxide, the method comprising contacting a composition comprising carbon dioxide with functional nanofibers having an plurality of amine groups on a surface thereof, wherein the nanofibers have an average cross-sectional dimension of 50 nm to 100 μm; and reacting at least a portion of the carbon dioxide with the amine groups to sequester at least a portion of the carbon dioxide.

Any polymer comprising primary, secondary, and/or tertiary amine groups is suitable for use in the functional nanofibers of the present invention. In some embodiments, a polyamine nanostructure comprises a polymer that includes a tertiary amine having an electron donating substituent (e.g., aryl, and the like) on the tertiary amine group.

There are two reaction pathways for CO₂ capture using the nanofibers of the present invention. Primary amines and sterically less hindered secondary amines can react directly with CO2 to form carbamate ions, as shown in the following Scheme:

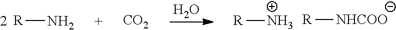

However, the absorption capacity of primary amines and sterically less hindered secondary amines can be limited by the reaction mechanism in which two equivalents of amines are needed to capture one equivalent of CO₂.

A second reaction pathway includes using sterically hindered secondary amines and tertiary amines act as proton scavengers and form an ammonium bicarbonate salt, as provided in the following Scheme:

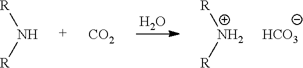

The presence of sterically hindered secondary amines and tertiary amines requires only one equivalent of amine to capture one equivalent of CO₂, and therefore can significantly improve the CO₂ capture capacity of the non-woven nanofiber mats. In preferred embodiments, a polymer comprising a plurality of secondary amine groups is coated on a nanofiber support to provide a polyamine polymer-coated nanofiber.

In some embodiments, a functional nanofiber of the present invention undergoes a mass increase of 10% or more after 20 minutes or more of exposure to carbon dioxide at a flow rate of 100 cubic feet per hour (cfh). In some embodiments, a functional nanofiber of the present invention undergoes a mass increase upon exposure to carbon dioxide that is at least 100% greater than a percentage increase in mass that a sequestering material having a cross-sectional dimension of 10 μm or more undergoes when exposed to the same carbon dioxide composition.

In some embodiments, a method comprises releasing the sequestered carbon dioxide from the functional nanofibers. Releasing processes include, but are not limited to, heating, chemically displacing, and the like, and combinations thereof. In some embodiments, releasing comprises heating a functional nanofiber comprising sequestered CO₂ for about 10 minutes to 10 hours at a temperature of 100° C. to 300° C., or for about 10 minutes to 1 hour at a temperature of 100° C. to 150° C., or for about 20 minutes at a temperature of about 120° C.

Not being bound by any particular theory, primary amines have higher heat of absorption for carbon dioxide than secondary and tertiary amines, which requires higher temperatures for carbon dioxide to be removed from a primary amine than for a secondary or a tertiary amine. Conversely, the lower heat of absorption for tertiary amines results in a lower reaction rate of tertiary amines with CO₂. Thus, a polyamine polymer that includes at least some secondary amines provides a balance between a low reaction rate and an increased energy requirement in order to regenerate the scrubber material after exposure to CO₂.

The present invention is also directed to a method of separating an oil from a composition, the method comprising contacting a composition comprising an oil with a filter that includes functional nanofibers having a plurality of hydrophilic functional groups on a surface thereof, wherein the functional nanofibers have an average cross-sectional dimension of 50 nm to 100 μm; and passing a non-oil portion of the composition through the filter to provide the oil on a surface of the filter.

In some embodiments, the functional nanofibers comprise a hydrophilic functional group such as, but not limited to, hydroxy, thio, primary amino, carboxy, carbonyl, aminocarbonyl, carbonylamino, and combinations thereof. Additional functional groups include, alkoxy, alkylthio, siloxy, silyl, alkylsilyl, alkylsilenyl, secondary amino, tertiary amino, alkylcarbonyl, alkylenedioxy, halo, perhalo, and combinations thereof.

Having generally described the invention, a further understanding can be obtained by reference to the examples provided herein. These examples are given for purposes of illustration only and are not intended to be limiting.

### EXAMPLES

### Example 1

Melt-blown nanofiber mats were prepared as follows. Polypropylene granules were added to a single screw extruder having a 3-zone heated barrel, which flowed into a heated hydraulic metering valve. The metered compositions were extruded through a 120-hole extruder die with a hole size of 0.015 in, an air gap of 0.06 in, a setback of 0.06 in, and a die angle of 30°. Other process conditions are listed in the following Table.

TABLE
Process parameters for preparing melt-blown mats
of the present invention.

| Parameter | Value | |
|---|---|---|
| Extruder Zone 1 Temperature | 173° C.-194° C. | |
| Extruder Zone 2 Temperature | 198° C.-231° C. | |
| Extruder Zone 3 Temperature | 197° C.-230° C. | |
| Valve Temperature | 227° C.-240° C. | |
| Extruder Die Zone 2 Temperature | 188° C.-243° C. | |
| Extruder Die Zone 3 Temperature | 193° C.-236° C. | |
| Extruder Die Zone 4 Temperature | 198° C.-243° C. | |
| Extruder Die Pressure | <100 | psi |
| Extruder Current | 4.6 | amps |
| Throughput | 0.33 | g/hole/min |
| Air Temperature at Die | 260° | C. |
| Air Pressure | 25 | psi |

| | |
|---|---|
| Extruder Die-to-Collector Distance | 200 mm-500 mm |
| Air Temperature at Collector | 197° C.-230° C. |
| Collector Speed | 1.35 m/min-10.7 m/min |

### Example 2

Melt-blown nanofiber mats were prepared using polypropylene by a process similar to that disclosed in Example 1, except that the metered compositions were extruded through a custom-manufactured melt-blowing die similar to those disclosed in U.S. Pat. No. 6,114,017, which is incorporated herein by reference in its entirety. The resulting polyolefin fibers had an average diameter of about 300 nm to 500 nm. The mats are water-proof and breathable, allowing gases to pass through but repelling aqueous liquids. The polypropylene mat had a basis weight of about 6 g/m².

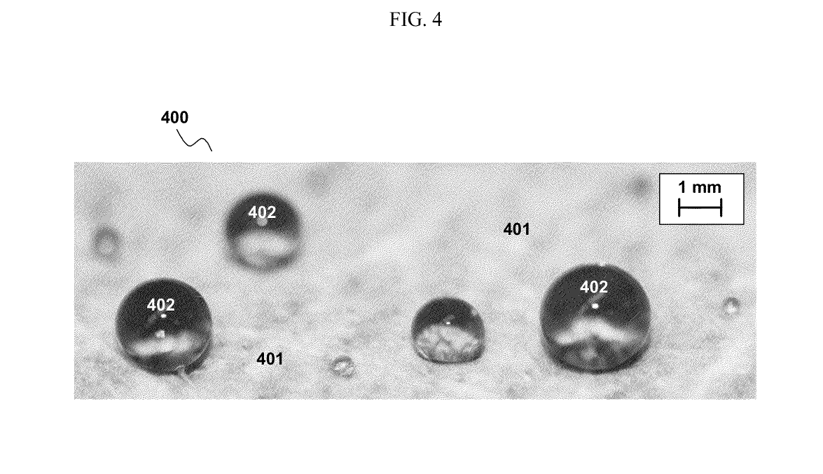

FIG. 4 provides an image of water containing methylene blue dye on a surface of a nanofiber mat. Referring to FIG. 4, the image, 400, shows that the mat surface, 401, is not wettable by water. The water droplets, 402 are isolated and have a contact angle greater of at least 150° with the surface of the nanofibers.

### Example 3

A melt-blown nanofiber mat, as prepared in Example 2 was placed between two glass cylinders. Water (about 150 mL) containing methylene blue dye was added to the top cylinder. The water did not leak through the mat at all, and was fully supported by the nanofiber mat. A pressurized stream of nitrogen was then bubbled through the nanofiber mat into the water.

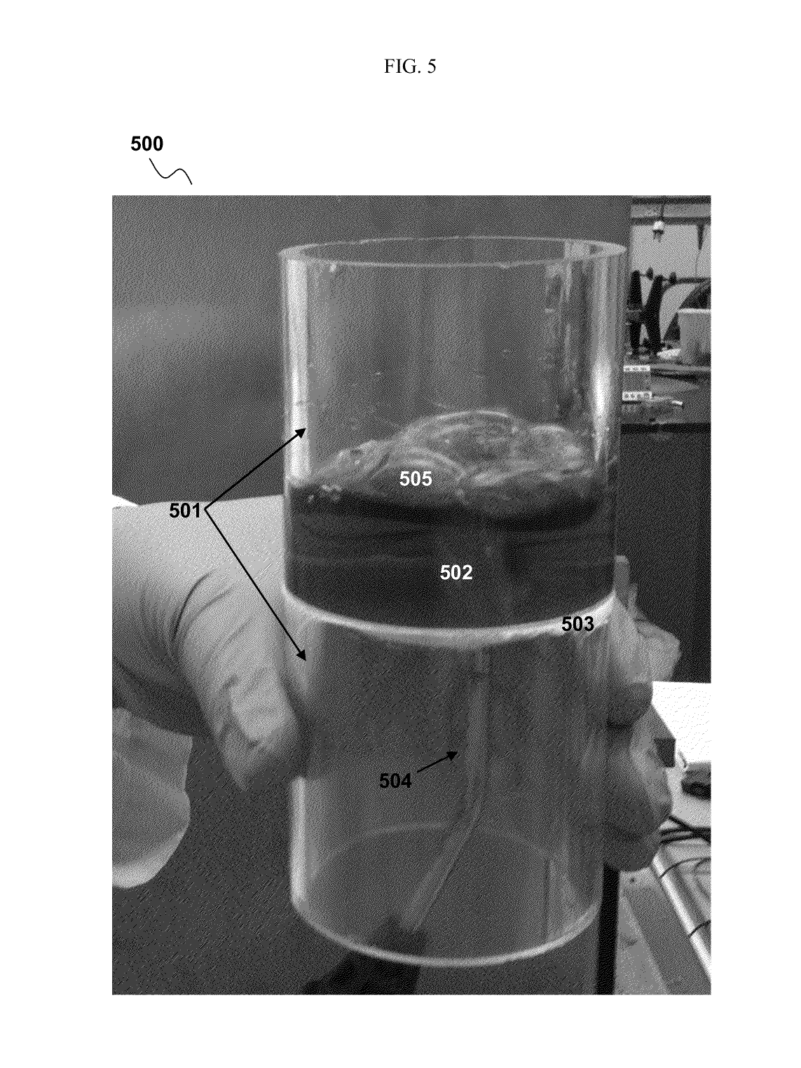

FIG. 5 provides an image, 500, of the glass cylinders, 501, containing the dyed water, 502. Referring to FIG. 5, the mat, 503, fully supports the water. A nitrogen feed, 504, is placed below the nanofiber mat, and nitrogen is passing through the mat forming bubbles, 505, on the surface of the water.

### Example 4

The melt-blown nanofiber mat, as prepared in Example 2 was placed between two glass cylinders. Water (about 20 mL) containing methylene blue dye and oil (octadecane) containing oil red dye were each added to the top cylinder. The water did not leak through the mat and was fully supported by the nanofiber mat. The oil passed around the water layer and through the mat into the lower glass cylinder.

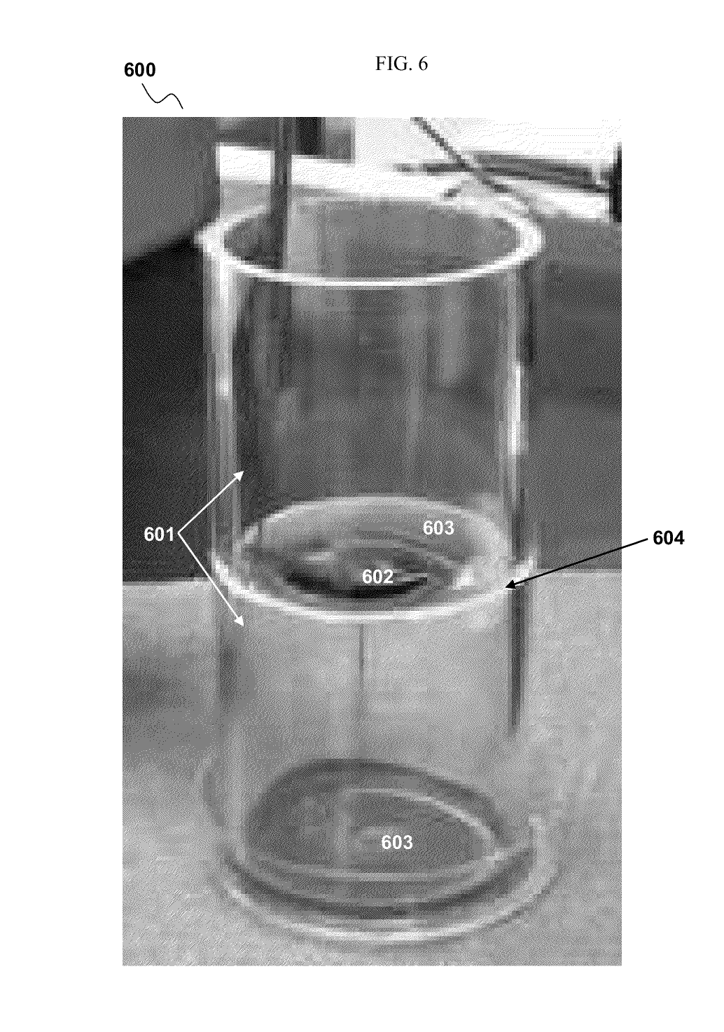

FIG. 6 provides an image, 600, of the glass cylinders, 601, containing the dyed water, 602, and dyed water, 603. Referring to FIG. 6, the mat, 604, fully supports the water, 602, while the oil, 603, passes through the functional nanofiber mat.

### Hypothetical Example A

Melt-blown polymer mats that are water-proof and breathable will be prepared using a fluoropolymer (e.g., polytetrafluoroethylene, a perfluoropolyether, a perfluoroalkoxy polymer, a fluorinated ethylene propylene polymer, an ethylene tetrafluoroethylene copolymer, polyvinyl fluoride, polyvinylidene fluoride, or ethylene chlorotrifluoroethylene) and the extruder die with a hole size of 0.002 in to 0.010 in, as described in Hypothetical Example 1. The resulting mats will be gas-permeable with a hydrophobic outer surface, a mean fiber diameter of about 50 nm to about 800 nm, and 90% or more of the nanofibers will have a diameter of about 1 μm or less.

### Hypothetical Example B

Melt-blown polymer mats that are water-proof and breathable will be prepared using a polyolefin (e.g., polyethylene, polypropylene, polystyrene, or polyvinyl chloride), a polyester, a polysulfone, a polyurethane, and the extruder die with a hole size of 0.008 in., as described in Example 2. The resulting mats will have a mean fiber diameter of about 300 nm to about 500 nm. The mats will be rendered further hydrophobic by functionalization with a fluorine-containing species. For example, the nanofiber mats will be chemically oxidized using an oxygen plasma or a corona discharge, and then chemically reacted with a fluorine-containing chemical species.

### Example 5

Melt-blown nanofiber mats were prepared according to the process of Example 2, supra, except that a surfactant (IRGASURF® HL 560, Ciba Specialty Chemicals, Inc., Tarrytown, N.Y.) at a concentration of about 6% by weight was mixed with the polyolefin prior to melt-blowing. The surfactant rendered the nanofiber mats wettable by aqueous solutions and polar solvents.

The melt-blown nanofiber mats were dip-coated with a polyamine (i.e., polyethyleneimine, CAS No. 9002-98-6, available from Sigma-Alrich Co., St. Louis, Mo.). A crosslinker (e.g., epichlorohydrin) was added to the polyamine to crosslink the amine coating on the nanofiber surface. After dip-coating, the mats were optionally pressed to remove excess absorbed liquid. The coated mats were then dried in a forced air oven at about 80° C. to about 120° C. for about 2 to 20 minutes.

### Example 6

Melt-blown nanofiber mats were prepared according to the process of Example 2, supra, except that a surfactant (IRGASURF® HL 560, Ciba Specialty Chemicals, Inc., Tarrytown, N.Y.) at a concentration of about 6% by weight was mixed with the polyolefin prior to melt-blowing. The surfactant rendered the nanofiber mats wettable by aqueous solutions and polar solvents. The melt-blown nanofiber mats had a basis weight of about 7 g/m² and a specific surface area of about 20 m²/g (as determined by BET N₂ adsorption).

The mats were coated with a polyamine (i.e., poly(ethylene imine, CAS No. 9002-98-6, available from Sigma-Alrich Co., St. Louis, Mo.). A crosslinker (epichlorohydrin) was added to the polyamine to crosslink the amine coating on the nanofiber surface. After dip-coating, the mats were optionally pressed to remove excess absorbed liquid. The coated nanofiber mats were then dried in a forced air oven at about 80° C. to about 120° C. for about 2 to 20 minutes.

The nanofiber mats had a loading of 20% to 30% by weight with the polyamine. Nonetheless, the permeability of the nanofiber mats (by N2) was about 5×10⁵ GPU. Thus, the polyamine coating did not adversely affect the gas permeability of the nanofiber mats.

### Example 7

The functional nanofiber mats prepared in Example 6 were exposed to a stream of CO₂ at a rate of 10 standard cubic feet per hour (scfh), and the CO₂ absorption was monitored gravimetrically over a period of 1 hr. Upon exposure to CO₂ the functional nanofiber mats rapidly gained in weight, indicating absorption of CO₂.

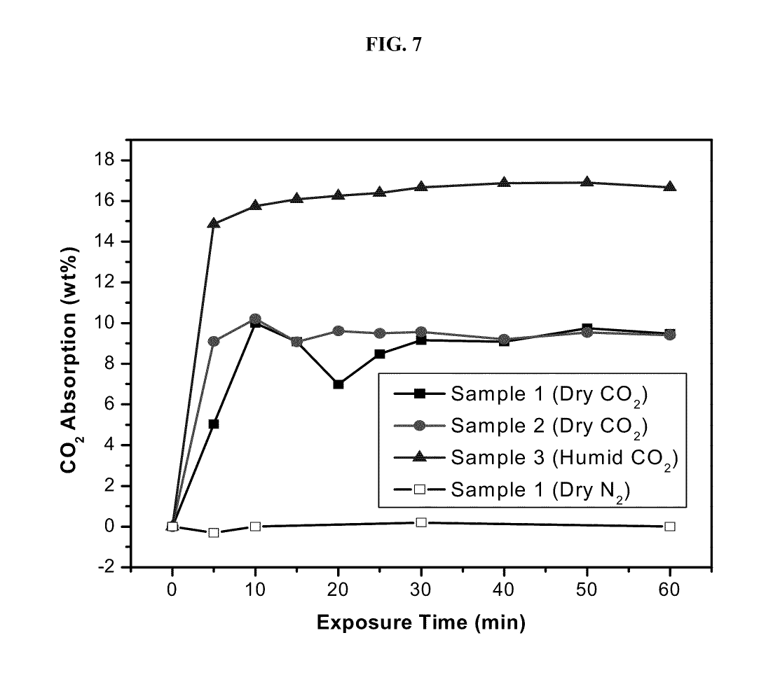

FIG. 7 provides a graphic representation of weight gain of the fiber mats upon exposure to CO₂. FIG. 7 is an average of date from 3 different samples of each material over 4 runs. Samples 1-3 were processed under nearly identical conditions. Sample 1 was first exposed to a stream of dry nitrogen as a control to ensure that the functional nanofibers were not affected by nitrogen. Referring to FIG. 7, the functional nanofiber (sample 1) did not absorb any nitrogen (black line, open squares). Sample 1 was then exposed to CO₂, at which time the sample rapidly increased in weight and stabilized after a weight gain of about 9%.

Referring to FIG. 7, sample 2 (red circles) was only exposed to CO₂ (not nitrogen and then CO₂). Sample 2 underwent a weight increase similar to that of sample 1, stabilizing at about 9% by weight of absorbed CO₂. Thus, the functional nanofibers in samples 1 and 2 appear to become nearly saturated within about 10 min of being exposed to pure CO₂.

Referring to FIG. 7, sample 3 was exposed to humidified CO₂ (about 50% RH, as measured using a hygrometer). Sample 3 underwent a weight increase of about 17%. Thus, the presence of water vapor in the CO₂ stream dramatically improved the apparent CO₂ absorption. While it is possible that some of the weight increase for Sample 3 can be attributable to water absorption, it is not surprising that water vapor improved CO₂ uptake by the functional nanofibers.

Not being bound by any particular theory, if the polyamine layer is hydrated, then this could potentially make more of the amine available for CO₂ capture. Depending on the hydration level and the cross-linking density, it is plausible that hydrated polymer coating can perform as an amine solution on the fiber surface, leading to improved CO₂ capacity. However, too high a hydration level could negatively affect permeation of CO₂ into the functional nanofiber mats and/or the durability/lifetime of the functional nanofiber mats.

For all samples, the CO₂ absorption was found to be reversible. Samples could be regenerated by placement in an oven at 120° C. for about 30 minutes.

### Example 8

Melt-blown nanofiber mats were prepared according to the process of Example 2, supra, except that a surfactant (IRGASURF® HL 560, Ciba Specialty Chemicals, Inc., Tarrytown, N.Y.) at a concentration of about 6% by weight was mixed with the polyolefin prior to melt-blowing. The surfactant rendered the nanofiber mats wettable by aqueous solutions and polar solvents. The melt-blown nanofiber mats had a basis weight of about 7 g/m² and a specific surface area of about 20 m²/g (as determined by BET N₂ adsorption).

### Example 9

A metal oxide coating was applied to the functional nanofiber mat of Example 7. An isopropanol solution comprising a metal oxide precursor (tetraethoxysilane, 0.5% to 5% by weight), water (0.5% to 10% by weight), and an acid (concentrated sulfuric acid, concentrated acetic acid, or concentrated hydrochloric acid, 0.5% to 10% by weight) was prepared and allowed to rest for 10 minutes to 24 hours. The nanofiber mat was saturated with the isopropanol solution by spraying or dip-coating (e.g., for less than 1 second to about 20 minutes). The isopropanol-saturated nanofiber mat was then optionally squeezed or compressed to remove residual absorbed liquid, and then dried in a forced air oven at about 80° C. to about 120° C. for 2 to 20 minutes.

### Example 10

A functional nanofiber mat, as prepared in Example 9 was placed between two glass cylinders. Water (about 20 mL) containing methylene blue dye and oil (octadecane) containing oil red dye were each added to the top cylinder. The oil did not leak through the hydrophilic nanofiber mat and was fully supported by the nanofiber mat. The water passed through the mat into the lower glass cylinder.

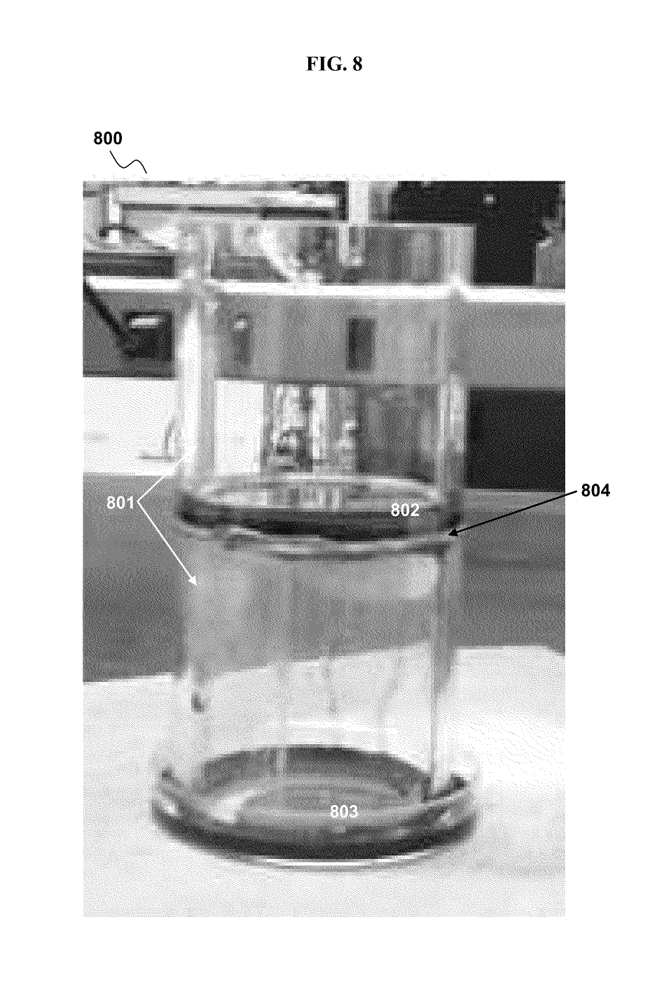

FIG. 8 provides an image, 800, of the glass cylinders, 801, containing the dyed oil, 802, and dyed water, 803. Referring to FIG. 8, the mat, 804, fully supports the oil, 802, while the water, 803, passes through the functional nanofiber mat.

### CONCLUSION

These examples illustrate possible embodiments of the present invention. While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

It is to be appreciated that the Detailed Description section, and not the Summary and Abstract sections, is intended to be used to interpret the claims. The Summary and Abstract sections can set forth one or more, but not all exemplary embodiments of the present invention as contemplated by the inventor(s), and thus, are not intended to limit the present invention and the appended claims in any way.

All documents cited herein, including journal articles or abstracts, published or corresponding U.S. or foreign patent applications, issued or foreign patents, or any other documents, are each entirely incorporated by reference herein, including all data, tables, FIGUREs, and text presented in the cited documents.

What is claimed is:

1. A method for sequestering carbon dioxide, the method comprising:
contacting a composition comprising carbon dioxide with functional nanofibers having an plurality of amine groups on a surface thereof, wherein the nanofibers have an average cross-sectional dimension of 50 nm to 100 μm; and
reacting at least a portion of the carbon dioxide with the amine groups to sequester at least a portion of the carbon dioxide.

2. The method of claim 1, comprising releasing the sequestered carbon dioxide from the functional nanofibers.

3. The method of claim 1, wherein at least a portion of the amine groups are secondary amines.

4. The method of claim 3, wherein the reacting comprises reacting at least a portion of the carbon dioxide with secondary amines in the presence of water to form an ammonium bicarbonate salt.

5. The method of claim 1, wherein the functional nanofibers comprise a polymer composition coated with a polyamine polymer selected from the group consisting of: a linear polyethyleneimine, a branched polyethyleneimine, an ethoxylated polyethyleneimine, polypropyleneimine, a polyallylamine, a poly(diallylamine), an ethoxylated polyallylamine, a polysilazane, and combinations thereof.

6. The method of claim 1, wherein the functional nanofibers comprise a melt-blown polymer selected from the group consisting of: polyethylene, polypropylene, polyethyleneterephthalate, polybutyleneterephthalate, polystyrene, polyvinyl chloride, polycarbonate, a polyamide, a polysulfone, a fluoropolymer, a copolymer thereof, and combinations thereof.

7. The method of claim 1, wherein the functional nanofibers comprise an electrospun polymer selected from the group consisting of: polyacrylonitrile, polyethyleneterephthalate, polybutyleneterephthalate, polystyrene, polystyrene-co-maleic anhydride, polyethylene-co-maleic anhydride, a copolymer thereof, cross-linked polyvinylalcohol, cross-linked polyacrylic acid, cross-linked polyvinylpyrrolidone, and combinations thereof.

8. A method of separating an oil from a composition, the method comprising:
contacting a composition comprising an oil with a filter that includes functional nanofibers having a plurality of hydrophilic functional groups on a surface thereof, wherein the functional nanofibers have an average cross-sectional dimension of 50 nm to 100 μm; and
passing a non-oil portion of the composition through the filter to provide the oil on a surface of the filter.

9. The method of claim 8, wherein the functional nanofibers comprise a hydrophilic functional group selected from the group consisting of: hydroxy, alkoxy, thio, thioalkyl, silyl, alkylsilyl, alkylsilenyl, siloxy, primary amino, secondary amino, tertiary amino, ammonium, carboxy, carbonyl, alkylcarbonyl, aminocarbonyl, carbonylamino, sulfonate, sulfate, phosphonic acid, boronic acid, ethylene glycol, a carbohydrate, a metal, a deoxyribonucleic acid, a ribonucleic acid, and combinations thereof.

10. The method of claim 8, wherein the functional nanofibers have an average cross-sectional dimension of 50 nm to 1 μm.

11. The method of claim 8, wherein the functional nanofibers comprise a functional group selected from the group consisting of: alkoxy, alkylthio, siloxy, silyl, alkylsilyl, alkylsilenyl, secondary amino, tertiary amino, alkylcarbonyl, alkylenedioxy, halo, perhalo, and combinations thereof.

12. A water-proof, breathable composition comprising a mat of non-woven polymer nanofibers having an inner surface and an outer surface, wherein at least the outer surface of the mat is hydrophobic, wherein the nanofibers have a mean diameter of about 50 nm to about 1 μm and 90% or more of the nanofibers have a diameter of 1 μm or less, and wherein the mat is permeable to a gas.

13. The water-proof, breathable composition of claim 12, wherein the polymer nanofibers comprise a polymer selected from: a polyolefin, a polyester, a fluoropolymer, a polysulfone, a polyurethane, a polysiloxane, and combinations thereof.

14. The water-proof, breathable composition of claim 13, wherein the polymer nanofibers comprise a polyolefin selected from the group consisting of: polyethylene, polypropylene, polystyrene, polyvinyl chloride, and combinations thereof.

15. The water-proof, breathable composition of claim 13, wherein the polymer nanofibers comprise a fluoropolymer selected from the group consisting of: polytetrafluoroethylene, a perfluoropolyether, a perfluoroalkoxy polymer, a fluorinated ethylene propylene polymer, an ethylene tetrafluoroethylene copolymer, polyvinyl fluoride, polyvinylidene fluoride, ethylene chlorotrifluoroethylene, and combinations thereof.

16. The water-proof, breathable composition of claim 12, wherein the polymer nanofibers comprise a functional group selected from the group consisting of: alkoxy, alkylthio, siloxy, silyl, alkylsilyl, alkylsilenyl, secondary amino, tertiary amino, alkylcarbonyl, alkylenedioxy, halo, perhalo, and combinations thereof.

17. A method of separating a liquid from a gas, the method comprising:
contacting a surface of the mat of non-woven polymer nanofibers of claim 12 with a flowing gas-liquid composition, wherein a gas portion of the gas-liquid composition passes through the mat and a liquid portion of the gas-liquid composition is repelled by a surface of the mat.

18. The method of claim 17, comprising collecting the liquid portion of the gas-liquid composition that is repelled by a surface of the mat.

19. The method of claim 17, wherein the polymer nanofibers comprise a polymer selected from: a polyolefin, a polyester, a fluoropolymer, a polysulfone, a polyurethane, and combinations thereof.

20. The method of claim 17, wherein the polymer nanofibers comprise a functional group selected from the group consisting of: alkoxy, alkylthio, siloxy, silyl, alkylsilyl, alkylsilenyl, secondary amino, tertiary amino, alkylcarbonyl, alkylenedioxy, halo, perhalo, and combinations thereof.
